(19) United States
(12) Patent Application Publication
(10) Pub. No.: US 2018/0070125 A1
(43) Pub. Date: Mar. 8, 2018

(54) REMOTE CONTROLLER AND METHOD FOR CONTROLLING THE SAME

(71) Applicant: Samsung Electronics Co., Ltd., Suwon-si (KR)

(72) Inventors: Jong-keun LEE, Seoul (KR); Tae-hoon KIM, Suwon-si (KR); Min-sup KIM, Suwon-si (KR); Myoung-jun LEE, Suwon-si (KR); Chae-young LIM, Bucheon-si (KR)

(73) Assignee: Samsung Electronics Co., Ltd., Suwon-si (KR)

(21) Appl. No.: 15/697,783

(22) Filed: Sep. 7, 2017

(30) Foreign Application Priority Data
Sep. 7, 2016 (KR) 10-2016-0115138

(51) Int. Cl. H04N 21/422; H04N 5/44

(52) U.S. Cl. CPC H04N 21/42204; H04N 5/4403; H04N 21/42203

(57) ABSTRACT

A remote controller is provided, which includes a transmitter, a microphone configured to receive from a display device an audio signal including information on a code set capable of controlling an external device connected to the display device through a predetermined carrier frequency, a signal processor configured to convert the received audio signal, and a microcomputer configured to acquire the code set capable of controlling the external device from a converted signal if the received audio signal is converted into a form that can be processed through the signal processor, and to control the transmitter to transmit a control signal for controlling the external device on the basis of the code set.

### CROSS-REFERENCE TO RELATED APPLICATIONS

This application claims priority from Korean Patent Application No. 10-2016-0115138 filed on Sep. 7, 2016 in the Korean Intellectual Property Office, the disclosure of which is incorporated herein by reference in its entirety.

### BACKGROUND OF THE INVENTION

### Field of the Invention

The present disclosure relates to a remote controller and a method for controlling the same, and more particularly, to a remote controller and a method for controlling the same, which can control an external device connected to a display device.

### Description of the Related Art

With the development of electronic technology, various external devices that provide content, such as a set-top box, DVD, and audio, may be connected to a display device to be used. However, in order to control such external devices, it is general to use remote controllers that are provided to the respective external devices. In this case, as the number of external devices is increased, the number of remote controllers is also increased.

Recently, a universal remote controller has been developed to enable one remote controller to control a plurality of electronic devices. In order to operate a universal remote controller, however, it is necessary that a control code set for controlling external devices is pre-stored in the remote controller.

Accordingly, it is required to search for schemes capable of controlling external devices even with a general remote controller in which the code set is not pre-stored.

### SUMMARY OF THE INVENTION

Exemplary embodiments of the present disclosure overcome the above disadvantages and other disadvantages not described above, and provide a remote controller and a method for controlling the same, which can receive an audio signal including information on a code set capable of controlling an external device, which is output from a display device, through a microphone of the remote controller, and can control the external device connected to the display device using the audio signal.

According to an aspect of the present disclosure, a remote controller includes a transmitter; a microphone configured to receive from a display device an audio signal including information on a code set capable of controlling an external device connected to the display device through a predetermined carrier frequency; a signal processor configured to convert the received audio signal; and a microcomputer configured to acquire the code set capable of controlling the external device from a converted signal if the received audio signal is converted into a form that can be processed through the signal processor, and to control the transmitter to transmit a control signal for controlling the external device on the basis of the code set.

The signal processor may convert the received audio signal into a TTL (Transistor-Transistor Logic) signal that can be processed by the microcomputer by amplifying the predetermined carrier frequency band in the received audio signal and passing a frequency band that is lower than the predetermined frequency band in the amplified audio signal.

The microcomputer may acquire from the converted signal the code set including a custom code that corresponds to the external device and a key code for controlling an operation of the external device.

The microcomputer may determine a key code that corresponds to a selected button on the basis of the code set if one of a plurality of buttons provided on the remote controller is selected, and may control the transmitter to generate and transmit to the external device an IR control signal including the custom code and the determined key code.

The predetermined carrier frequency may include a carrier frequency of 18 kHz.

According to another aspect of the present disclosure, a method for controlling a remote controller includes receiving from a display device an audio signal including information on a code set capable of controlling an external device connected to the display device through a predetermined carrier frequency; converting the received audio signal; and acquiring the code set capable of controlling the external device from a converted signal if the received audio signal is converted into a form that can be processed, and transmitting a control signal for controlling the external device on the basis of the code set.

The converting the received audio signal may include converting the received audio signal into a TTL signal by amplifying the predetermined carrier frequency band in the received audio signal and passing a frequency band that is lower than the predetermined frequency band in the amplified audio signal.

The acquiring the information on the code set capable of controlling the external device may include acquiring from the converted signal the code set including a custom code that corresponds to the external device and a key code for controlling an operation of the external device.

The transmitting the control signal may include determining a key code that corresponds to a selected button on the basis of the code set if one of a plurality of buttons provided on the remote controller is selected, and generating and transmitting to the external device an IR control signal including the custom code and the determined key code. The predetermined carrier frequency may include a carrier frequency of 18 kHz. According to another aspect of the present disclosure a non-transitory computer readable storage medium may store a method as discussed above.

The remote controller does not store a code set capable of controlling the external device connected to the display device.

According to another aspect of the present disclosure, a method for controlling a remote controller that does not store a code set capable of controlling an external device connected to a display, the method comprising converting a received audio signal including the code set capable into a logic signal code set; and transmitting a control signal for controlling the external device based on the logic signal code set.

According to the aspects of the present disclosure as described above, a remote controller capable of controlling an external device connected to a display device can be provided through addition of only a microphone and a minimum circuit to the remote controller, and thus a user can control the external device more effectively.

Additional and/or other aspects and advantages of the disclosure will be set forth in part in the description which follows and, in part, will be obvious from the description, or may be learned by practice of the disclosure.

### BRIEF DESCRIPTION OF THE DRAWING FIGURES

The above and/or other aspects of the present disclosure will be more apparent by describing certain exemplary embodiments of the present disclosure with reference to the accompanying drawings, in which:

FIG. 1 is a diagram explaining a remote control system according to an embodiment of the present disclosure;

FIG. 2 is a block diagram explaining the configuration of a display device according to an embodiment of the present disclosure;

FIG. 3 is a block diagram explaining the configuration of a remote controller according to an embodiment of the present disclosure;

FIG. 4 is a diagram explaining the configuration of a signal processor according to an embodiment of the present disclosure;

FIG. 5 is a diagram explaining an audio signal that is converted by a signal processor according to an embodiment of the present disclosure;

FIG. 6 is a diagram explaining a process in which a remote controller acquires code set information of an external device from a display device according to an embodiment of the present disclosure; and

FIG. 7 is a flowchart explaining a method for a remote controller to control an external device connected to a display device according to an embodiment of the present disclosure.

### DETAILED DESCRIPTION OF THE EXEMPLARY EMBODIMENTS

Terms used in the description and claims are selected as general terms in consideration of functions of the present disclosure. However, such terms may differ depending on intentions of those skilled in the art to which the present disclosure pertains, legal or technical interpretation, and advent of new technology. Further, some terms are optionally selected by inventors. Such terms may be interpreted as meanings defined in the description, and may be interpreted on the basis of the whole contents of the description and typical technical common sense in the corresponding technical fields unless they have been clearly and specially defined.

Further, in explaining the present disclosure, detailed explanation of related well-known functions or configurations is contracted or omitted if it is determined that such explanation would obscure the gist of the present disclosure in unnecessary detail.

Further, although exemplary embodiments of the present disclosure will be described in detail with reference to the accompanying drawings and the contents described in the drawings, the present disclosure is not limited or restricted to such embodiments.

Hereinafter, a remote control system according to an embodiment of the present disclosure will be described with reference to the accompanying drawings.

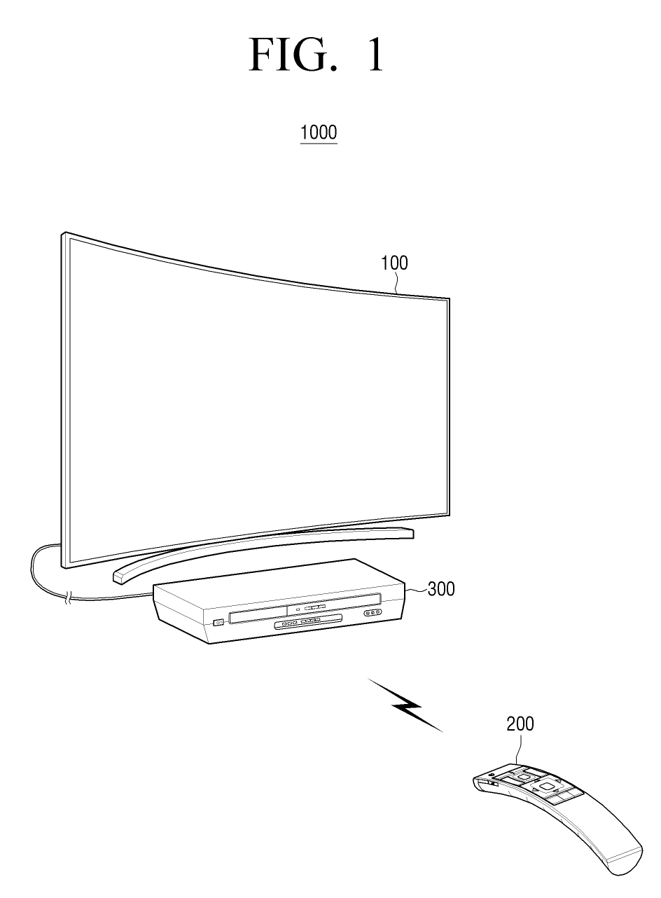

FIG. 1 is a diagram explaining a remote control system according to an embodiment of the present disclosure.

As illustrated in FIG. 1, a remote control system 1000 includes a display device 100, a remote controller 200, and an external device 300.

The display device 100 is connected to the external device 300. For example, the display device 100 and the external device 300 may be connected to each other through a high definition multimedia interface (HDMI) port, a universal serial bus (USB) port, or the like. Accordingly, the display device 100 may receive from the external device 300 information on a code set capable of controlling the external device 300. However, the display device 100 does not necessarily receive from the external device 300 the information on the code set of the external device 300. The display device 100 may download and store the code set of the external device 300 through accessing an external server (not illustrated) through a network, or the information on the code set of the external device 300 may be pre-stored in the display device 100.

Further, the display device 100 may output an audio signal.

Specifically, the display device 100 may output the audio signal through a speaker provided in the display device 100, and the output audio signal may include the information on the code set capable of controlling the external device 300.

The display device 100 that performs the above-described function may be implemented by a TV, and the external device 300 may be implemented by a set-top box or a Blu-ray disc. However, they are merely exemplary, and various types of devices may implement the display device 100 that displays an image and the external device 300 that provides an image to the display device 100.

The remote controller 200 may control the display device 100. Specifically, the remote controller 200 may be implemented to control the display device 100 in a manner that it transmits a control signal for performing turn-on/off, channel control, or volume control to the display device 100 in an IR method on the basis of the code set preset in the remote controller 200.

On the other hand, the remote controller 200 may control the external device 300.

In this case, however, since the remote controller 200 is a device for controlling the display device 100, it should be additionally set to control the external device 300 on the basis of the code set capable of controlling the external device 300.

Here, in relation to a specific electronic device, the code set may include a set of information on respective keys of the remote controller 200 and information on signals that are generated when the respective keys are selected.

On the other hand, the external device 300 is operated by different code sets for respective manufacturers.

Accordingly, in order for the remote controller 200 to control the external device 300, the code set of the external device 300 is additionally necessary.

However, since the remote controller 200 is a device that is provided with only an analog communication circuit, it should acquire the information on the code set capable of controlling the external device 300 using the audio signal that is output from the display device 100.

That is, in order to control the external device 300, the remote controller 200 should receive the audio signal including the code set information of the external device 300 from the display device 100, and should acquire the code set of the external device 300 through conversion of the audio signal into a digital signal.

Hereinafter, a method for receiving an audio signal including information on a code set of an external device 300 from a display device 100 and controlling the external device 300 through conversion of the received audio signal into a digital signal will be described in more detail.

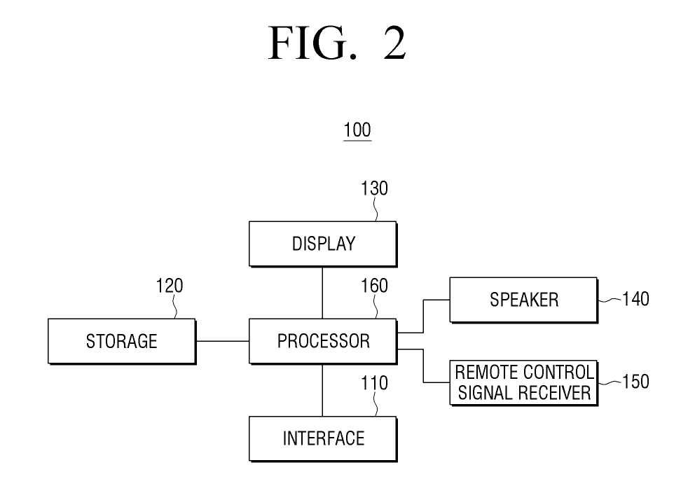

Referring to FIG. 2, a display device 100 includes an interface 110, storage 120, a display 130, a speaker 140, a remote control signal receiver 150, and a processor 160.

The interface 110 may be connected to an external device 300. Accordingly, the interface 110 may receive various pieces of data from the external device 300.

For this, the interface 110 may be implemented by various types of ports. For example, in the case where the interface 110 is connected to the external device 300 according to an HDMI type, it may include an HDMI port. However, this is merely exemplary, and the interface 110 may also be connected to the external device 300 according to another type, such as a connector or a universal serial bus (USB).

Specifically, the interface 110 may receive content from the external device 300. That is, the interface 110 may receive a video signal and an audio signal for the content from the external device 300.

Further, the interface may receive from the external device 300 information on a code set of or for the external device 300.

Here, the code set may include various pieces of information about a control signal capable of controlling the external device 300. For example, the code set may include information on a custom code for identifying the external device 300 and a key code for the external device 300 to perform a specific operation.

In this case, different custom codes and key codes may be used depending on manufacturers and kinds of electronic devices, and in order to control a specific external device through the remote controller 200, a code set that coincides with the corresponding external device may be required.

The storage 120 stores various pieces of data therein. Specifically, the storage 120 may store information on a code set received from the external device 300. The storage 120 may include a non-transitory computer readable storage medium, such as a Read Only Memory (ROM).

In this case, since a different code set is used for each external device 300, the storage 120 may match and store a code set that coincides with the external device 300.

For this, the storage 120 may be implemented by various storage media, such as hard discs, nonvolatile memories, and volatile memories.

On the other hand, the storage 120 may store therein the operating system (OS) for controlling the whole operation of constituent elements of the display device 100 and commands or data related to the constituent elements of the display device 100.

Accordingly, the processor 160 may boot the operating system to control a plurality of hardware or software constituent elements connected to the processor 160, may load a command or data that is received from at least one of other constituent elements to process the command or data, and may store various pieces of data in the nonvolatile memory.

The display 130 displays various screens.

For example, the display 130 may display a video signal received from the interface 110.

For this, the display 130 may be implemented by a liquid crystal display (LCD) or an organic light emitting diode (OLED) display.

The speaker 140 outputs various audio signals.

For example, the speaker 140 may output an audio signal received from the interface 110.

Further, the speaker 140 may output the audio signal including the code set, and detailed contents related to this will be described later.

The remote control signal receiver 150 may receive a control signal from the remote controller 200.

Here, the control signal is a signal for controlling the display device 100, and may be an IR signal that includes a custom code for the display device 100 and a key code for performing a specific function of the display device 100.

The processor 160 controls the whole operation of the display device 100. For this, the processor 160 may include a central processing unit (CPU), a random access memory (RAM), and a read only memory (ROM), and may perform control of other constituent elements included in the display device 100 or data processing.

First, if the processor 160 is connected to the external device 300 through the interface 110, it may control the interface 110 to transmit a transmission request command for a code set to the external device 300.

In this case, the external device 300 may transmit information on the code set to the display device 100, and the processor 160 may store the code set received from the external device 300 in the storage 120.

On the other hand, in the above-described example, it is described that the code set is received from the external device 300, but this is merely exemplary. That is, the display device 100 may download and store the code set of the external device 300 through accessing an external server (not illustrated) through a network, or the code set of the external device 300 may be pre-stored in the display device 100 during manufacturing of the display device 100.

Further, if the control signal that is transmitted by the remote controller 200 is received through the remote control signal receiver 150, the processor 160 may control the display device 100 to perform an operation corresponding to the received control signal.

For example, the processor 160 may determine whether the control signal that is received from the remote controller 200 corresponds to a signal capable of controlling the display device 100, and may perform an operation corresponding to the key code included in the received control signal (e.g., turn-on/off, channel switching, or volume control).

On the other hand, the processor 160 may transmit the information on the code set of the external device 300 to the remote controller 200.

Specifically, the processor 160 may output the audio signal including the information on the code set of the external device 300 using the speaker 140.

For example, the processor 160 may modulate the signal including the information on the code set of the external device to generate an analog type signal, and may output the analog signal through the speaker 140.

In this case, the processor 160 may control the speaker 140 to output the audio signal through a specific carrier frequency.

Here, the carrier frequency used to transmit the code set may be included in a non-audible frequency band, and for example, may be a frequency band of 18 kHz.

As described above, the processor 160 may output the information on the code set as the audio signal that is an analog signal through the speaker 140.

On the other hand, if a transmission request for the code set is received from the remote controller 200, the processor 160 may output the audio signal including the information on the code set of the external device 300 through the speaker 140.

For example, if a specific button that is provided on the remote controller 200 is selected, the remote controller 200 may transmit the transmission request for the code set of the external device 300 to the display device 100, and the processor 160 may output the audio signal including the information on the code set of the external device 300 through the speaker 140 in accordance with the transmission request for the code set that is received from the remote controller 200.

Further, the processor 160 may display a menu for the transmission request for the code set through the display 130, and if the corresponding menu is selected in accordance with the control signal received from the remote controller 200, the processor 160 may output the audio signal including the information on the code set of the external device 300 through the speaker 140.

On the other hand, the processor 160 may output the audio signal including the information on the code set of the external device 300 that is selected in accordance with a user command through the speaker 140.

For this, the processor 160 may display on the display 130 a user interface (UI) for selecting one of external devices 300 connected to the display device 100.

Accordingly, the processor 160 may output the audio signal including the information on the code set of the external device 300 that is selected through the UI through the speaker 14p. In this case, the user command for selecting the external device 300 may be received from the remote controller 200.

On the other hand, the display device 100 may further include various constituent elements in addition to the constituent elements as described above with reference to FIG. 2.

For example, the display device 100 may further include a receiver (not illustrated), a signal processor (not illustrated), and an inputter (not illustrated), and the operations of such constituent elements may be controlled by the processor 160.

The receiver (not illustrated) may receive broadcasting content (or broadcasting signal). The broadcasting content may include video, audio, and additional data (e.g., EPG), and the receiver (not illustrated) may receive the broadcasting content from various sources, such as ground-wave broadcasting, cable broadcasting, satellite broadcasting, and internet broadcasting.

For example, in order to receive the broadcasting content that is transmitted from broadcasting stations, the receiver (not illustrated) may be implemented to include a tuner (not illustrated), a demodulator (not illustrated), and an equalizer (not illustrated).

The signal processor (not illustrated) performs signal processing with respect to the content that is received through the interface 110 or the receiver (not illustrated).

Specifically, the signal processor (not illustrated) may perform decoding, scaling, and frame rate conversion with respect to an image constituting the content to convert the image into a form that can be output through the display 130. Further, the signal processor (not illustrated) may perform decoding of an audio constituting the content to convert the audio into a form that can be output through the speaker 140.

The inputter (not illustrated) receives an input of various user commands. The processor 160 may perform a function corresponding to the user command that is input through the inputter (not illustrated).

For example, the inputter (not illustrated) may receive an input of a user command for performing turn-on/off, channel change, or volume control, and the processor 160 may change the channel or control the volume in accordance with the input user command.

For this, the inputter (not illustrated) may be implemented by an input panel. The input panel may be configured as a touchpad, a keypad including various kinds of function keys, numeral keys, special keys, and character keys, or a touch screen.

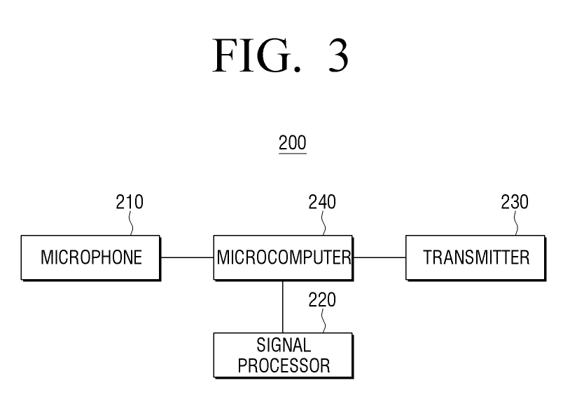

Referring to FIG. 3, a remote controller 200 includes a microphone 210, a signal processor 220, a transmitter 230, and a microcomputer 240.

The microphone 210 receives an audio signal. Specifically, the microphone 210 may receive the audio signal that is output from the speaker 140 of the display device 100.

The signal processor 220 converts the audio signal into a digital signal. Specifically, the signal processor 220 may convert the audio signal that is received through the microphone 210 into a digital signal that can be processed by the microcomputer 240.

For this, the signal processor 220 may include a band pass amplifier and a low pass filter.

Here, the band pass amplifier may amplify a predetermined frequency band in the audio signal that is received through the microphone 210, and the low pass filter may block a frequency band that is higher than the predetermined frequency band in the audio signal that is amplified by the band pass amplifier and may pass a frequency band that is lower than the predetermined frequency band.

As described above, the signal processor 220 may convert the audio signal that is received through the microphone 210 into the digital signal by making the audio signal pass through the band pass amplifier and the low pass filter.

Here, the converted digital signal is a signal in the form that can be processed by the microcomputer 240, and may be, for example, a TTL signal.

The transmitter 230 transmits various signals.

Specifically, the transmitter 230 may transmit an IR signal for controlling the display device 100. For example, the transmitter 230 may transmit the IR signal for making the display device 100 perform an operation corresponding to the key code (e.g., turn-on/off, channel switching, or volume control).

Further, the transmitter 230 may transmit a code set transmission request signal of the external device 300 to the display device 100.

Here, the code set transmission request signal may include information for making the display device 100 output the audio signal including the code set information of the external device 300 connected to the display device 100.

Further, the transmitter 230 may transmit an IR signal for controlling the external device 300 to the external device 300. For example, the transmitter may transmit the IR signal for making the external device 100 perform an operation corresponding to the key code (e.g., turn-on/off, channel switching, or volume control). For this, as described above, the remote controller 200 should be in a state where the code set of the external device 300 for controlling the external device 300 is additionally set.

The microcomputer 240 performs the whole operation of the remote controller 200. For this, the microcomputer 240 may include a central processing unit (CPU), a random access memory (RAM), and a read only memory (ROM), and may perform control of other constituent elements included in the remote controller 200 or data processing.

First, the microcomputer 240 may control the transmitter 230 to transmit the code set transmission request of the external device 300 to the display device 100. For example, the microcomputer 240 may control the transmitter 230 to transmit the code set transmission request of the external device 300 to the display device 100 in an IR method.

Further, if a menu for the code set transmission is displayed on the display device 100, the microcomputer 240 may control the transmitter 230 to transmit to the display device 100 a control signal for selecting a UI included in the menu.

For example, if a UI related to the external device 300 connected to the display device 100 is displayed on the screen of the display device 100, the microcomputer 240 may control the transmitter 230 to transmit the control signal for selecting the UI for a specific external device 300 to the display device 100.

In this case, the UI may be selected according to a user command that is input through the inputter (not illustrated) of the remote controller 200, and the microcomputer 240 may control the transmitter 230 to transmit the code set transmission request for the external device 300 selected according to the input user command.

Further, the microcomputer 240 may control the microphone 210 to receive the audio signal that is output from the display device 100.

For example, if the display device 100 outputs the audio signal including the code set information for the external device 300 of the selected UI in accordance with the user command for selecting the UI for the external device 300 connected to the display device 100, the microcomputer 240 may control the microphone 210 to receive the audio signal that is output from the display device 100.

Further, the microcomputer 240 may control the signal processor 220 to convert the audio signal that is received through the microphone 210 into a digital signal.

Specifically, if the audio signal including the code set information of the external device 300 connected to the display device 100 is received through the microphone 210, the microcomputer 240 may control the signal processor 220 to convert the audio signal into the digital signal. That is, the microcomputer 240 may control the signal processor 220 to amplify the predetermined frequency band in the audio signal that is received through the microphone 210 through the band pass amplifier and to pass only a frequency band that is lower than the predetermined frequency band in the audio signal that is amplified by the band pass filter through the low pass filter.

Further, the microcomputer 240 may acquire the code set of the external device 300 through the converted digital signal.

Specifically, the microcomputer 240 may acquire the code set of the external device 300, that is, code information for each command, from the digital signal that is converted by the signal processor 220. Here, the code information for each command may include information on a custom code for the external device 300 and the key code for performing a specific function of the external device 300.

Thereafter, the microcomputer 240 may control the external device 300 using the code set of the external device 300.

For this, the microcomputer 240 may generate an IR control signal for controlling the external device 300 on the basis of the code set of the external device 300. Further, the microcomputer 240 may control the transmitter 230 to transmit the generated IR control signal to the external device 300. Here, the IR control signal may include the code information of the external device 300.

As described above, through the above-described process, the microcomputer 240 may acquire the code set of the external device 300 and may set the remote controller 200 that can control the external device 300 using the acquired code set.

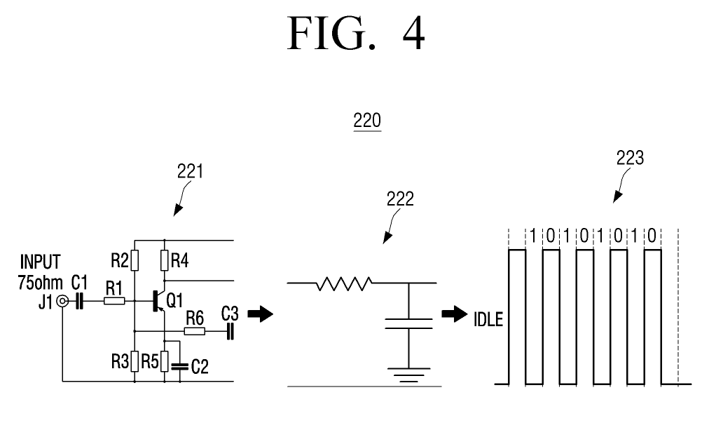

FIG. 4 is a diagram explaining the configuration of a signal processor according to an embodiment of the present disclosure.

Referring to FIG. 4, the signal processor 220 may include a band pass amplifier 221 and a low pass filter 222.

Here, the band pass amplifier may amplify a predetermined frequency band in the audio signal that is received through the microphone 210, and the low pass filter may pass only a frequency band that is lower than the predetermined frequency band in the audio signal that is amplified by the band pass amplifier.

As described above, the signal processor 220 may convert the audio signal that is received through the microphone 210 into the digital signal by making the audio signal pass through the band pass amplifier and the low pass filter.

Here, the converted digital signal 223 is a signal in the form that can be processed by the microcomputer 240, and may be, for example, a TTL signal.

On the other hand, the circuit structure as illustrated in FIG. 4 merely corresponds to an embodiment, and the circuit structures of the band pass amplifier 221 and the low pass filter 222 are not necessarily limited thereto.

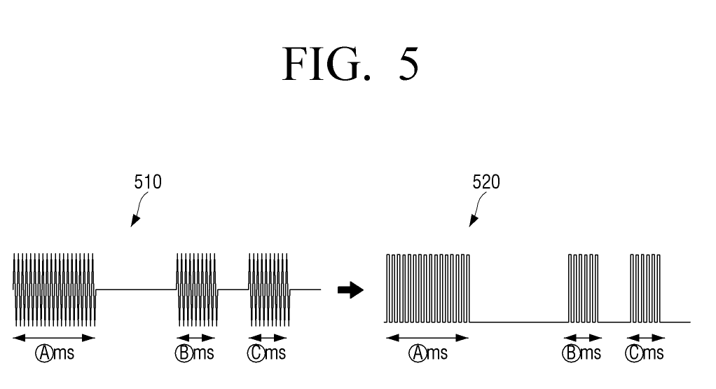

FIG. 5 is a diagram explaining an audio signal that is converted by a signal processor according to an embodiment of the present disclosure.

Referring to FIG. 5, an audio signal 510 that is initially received through the microphone 210 is in the form of an analog signal.

Here, since the remote controller 200 is a device having only an analog communication circuit, the microphone 210 can receive only the audio signal 510 that is modulated in the analog form.

Thereafter, the audio signal 510 is converted into a digital signal 520 by the signal processor 220.

Specifically, the audio signal 510 at the predetermined frequency band through the band pass amplifier, and the amplified audio signal may be converted into the digital signal 520 through passing only a frequency band that is lower than the predetermined frequency band through the low pass filter.

Here, the converted digital signal is a signal in the form that can be processed by the microcomputer 240, and may be, for example, a TTL signal.

On the other hand, the predetermined frequency is the frequency for the audio signal that is output from the speaker of the display device 100. The predetermined frequency is included in a non-audible frequency band, and may be, for example, a frequency band of 18 kHz.

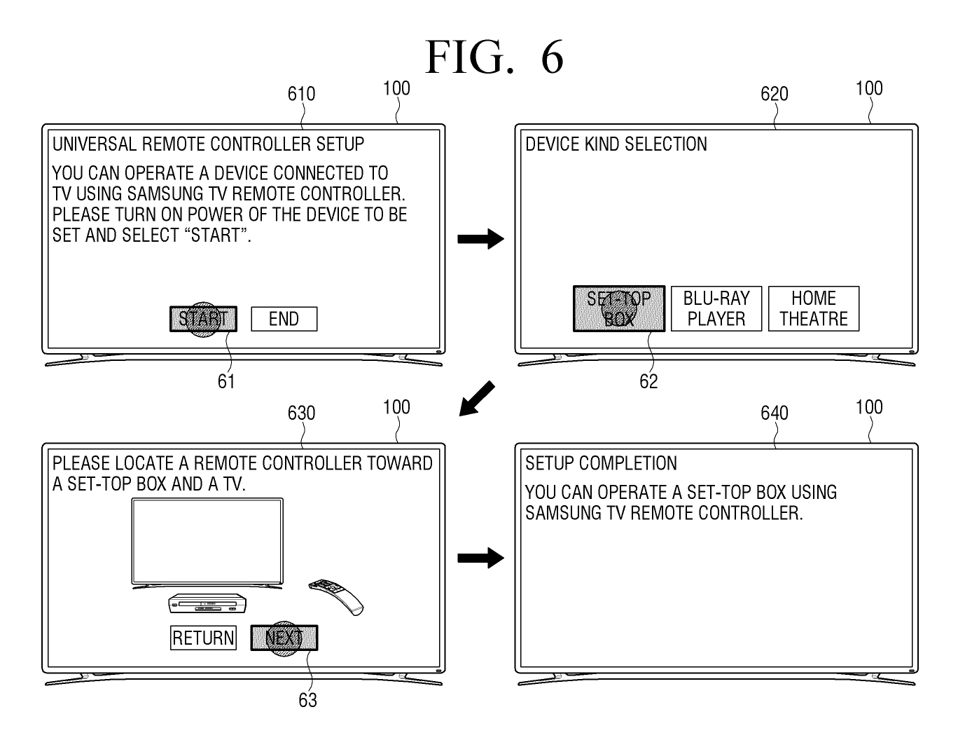

FIG. 6 is a diagram explaining a process in which a remote controller acquires code set information of an external device from a display device according to an embodiment of the present disclosure.

First, if a signal for requesting code set information of the external device 300 connected to the display device 100 is received from the remote controller 200, the display device 100 may display a universal remote control setup screen 510.

In this case, if a start icon 51 for the universal remote control setup is selected through the inputter (not illustrated) of the remote controller 200, the display device 100 may display a screen 520 including an external device list.

Here, the external device list may include one or more external devices 300 connected to the display device 200. For example, the external device list may include a set-top box and a Blu-ray player connected to the display device 200.

Next, if an icon 52 of any one external device included in the external device list, for example, a set-top box, is selected through the inputter (not illustrated) of the remote controller 200, the display device 100 may display a screen 530 including a message for causing a user to locate the remote controller 200 toward the display device 100.

Further, if an icon 53 for going over to the next step is selected through the inputter (not illustrated) of the remote controller 200, the display device 100 may output the audio signal including the code information of the set-top box through the speaker.

In this manner as described above, if the audio signal including the code information of the external device 300 is output through the display device 100 and the remote controller 200 receives the audio signal through the microphone, the display device 100 may display a setup completion screen 540.

Further, the remote controller 200 may convert the received audio signal to acquire the code information of the external device 300, and may control the external device 300, that is, set-top box, using the acquired code information.

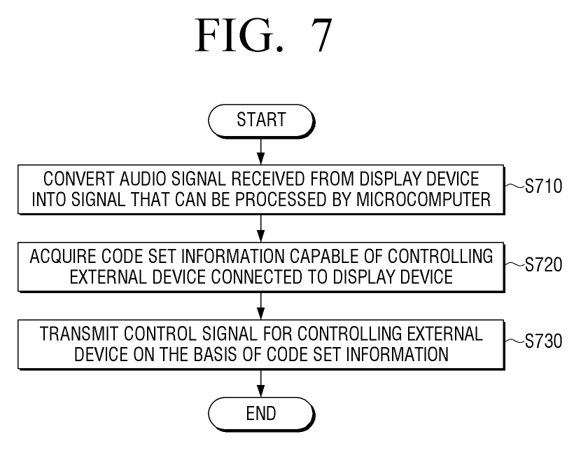

FIG. 7 is a flowchart explaining a method for a remote controller to control an external device connected to a display device according to an embodiment of the present disclosure. The method may be stored on a non-transitory computer readable storage medium, such as a Read Only Memory (ROM) of the remote controller. Here, the display device is connected to the external device, and the remote controller may be provided with a microphone.

First, the remote controller transmits a signal for requesting code set information of the external device connected to the display device to the display device.

Then, the remote controller receives an audio signal including code set information of the external device from the display device, and the microcomputer converts the audio signal into a form that can be processed by the microcomputer (S710).

That is, the remote controller converts the audio signal that is output from the display device into a digital signal that can be processed by the microcomputer. Here, an example of the digital signal may be a TTL signal.

On the other hand, the method for converting the audio signal that is received from the display device into the digital signal has been described.

Thereafter, the remote controller acquires the code set capable of controlling the external device from the converted signal (S720).

Further, the remote controller may generate an infrared signal for controlling the external device on the basis of the code set of the external device, and may transmit the generated infrared signal to the external device to control the external device (S730).

The foregoing exemplary embodiments and advantages are merely exemplary and are not to be construed as limiting the present disclosure. The present teaching can be readily applied to other types of apparatuses. Also, the description of the exemplary embodiments of the present disclosure is intended to be illustrative, and not to limit the scope of the claims, and many alternatives, modifications, and variations will be apparent to those skilled in the art.

What is claimed is:

1. A remote controller, comprising:
a transmitter;
a microphone configured to receive from a display device an audio signal including information on a code set capable of controlling an external device connected to the display device via a predetermined carrier frequency;
a signal processor configured to convert a received audio signal; and
a microcomputer configured to acquire the code set capable of controlling the external device from a converted signal when the received audio signal is converted into a form that can be processed via the signal processor, and to control the transmitter to transmit a control signal for controlling the external device on a basis of the code set.

2. The remote controller as claimed in claim 1, wherein the signal converts the received audio signal into a TTL (Transistor-Transistor Logic) signal that can be processed by the microcomputer by amplifying the predetermined carrier frequency band of the received audio signal and passing a frequency band that is lower than a predetermined frequency band of an amplified audio signal.

3. The remote controller as claimed in claim 1, wherein the microcomputer acquires from the converted signal the code set including a custom code that corresponds to the external device and a key code for controlling an operation of the external device.

4. The remote controller as claimed in claim 3, wherein the microcomputer determines a key code that corresponds to a selected button on a basis of the code set when one of a plurality of buttons provided on the remote controller is selected, and controls the transmitter to generate and transmit to the external device an IR control signal including the custom code and the determined key code.

5. The remote controller as claimed in claim 1, wherein the predetermined carrier frequency comprises a carrier frequency of 18 kHz.

6. A method for controlling a remote controller, comprising:
receiving from a display device an audio signal including information on a code set capable of controlling an external device connected to the display device via a predetermined carrier frequency;
converting a received audio signal; and
acquiring the code set capable of controlling the external device from a converted signal when the received audio signal is converted into a form that can be processed, and transmitting a control signal for controlling the external device on a basis of the code set.

7. The method as claimed in claim 6, wherein the converting the received audio signal comprises converting the received audio signal into a TTL (Transistor-Transistor Logic) signal by amplifying a predetermined carrier frequency band of the received audio signal and passing a frequency band that is lower than the predetermined frequency band of the amplified audio signal.

8. The method as claimed in claim 6, wherein the acquiring the information on the code set capable of controlling the external device comprises acquiring from the converted signal the code set including a custom code that corresponds to the external device and a key code for controlling an operation of the external device.

9. The method as claimed in claim 8, wherein the transmitting the control signal comprises determining a key code that corresponds to a selected button on a basis of the code set when one of a plurality of buttons provided on the remote controller is selected, and generating and transmitting to the external device an IR control signal including the custom code and the determined key code.

10. The method as claimed in claim 6, wherein the predetermined carrier frequency comprises a carrier frequency of 18 kHz.

11. A non-transitory computer readable storage medium storing a method as claimed in claim 6.

12. The remote controller as claim in claim 1, wherein the remote controller does not store a code set capable of controlling the external device connected to the display device.

13. The method as claimed in claim 6, wherein the remote controller does not store a code set capable of controlling the external device connected to the display device.
